(19) United States
(12) Patent Application Publication
(10) Pub. No.: US 2009/0002154 A1
(43) Pub. Date: Jan. 1, 2009

(54) Locating Device for Identifying the Location of Misplaced Items and Method Therein

(76) Inventor: Saul Ryan, Spring Hill, TN (US)

Correspondence Address: PATWRITE LLC, 408 W. MAIN ST., MARSHALLTOWN, IA, 50158-5759, US

(21) Appl. No.: 11/768,219

(22) Filed: Jun. 26, 2007

(51) Int. Cl. G08B 1/08

(52) U.S. Cl. 340/539.16; 340/539.1

(57) ABSTRACT

A locating device has a base unit with a plurality of selectable buttons that are assigned to items a user wants to keep track of. Self adhesive transceivers are attached to the items. The base is permanently attached to a wall or cupboard. In another embodiment, a wearable bracelet works in conjunction with the base unit to provide directional information as well as serving as a portable locator unit. Both the base unit and the bracelet utilize buttons that are customizable with icons that represent the devices they locate. A microprocessor performs signal processing required to selectively transmit and receive unique electronic identifiers associated with each transceiver units. Each transceiver is adapted to receive a unique identifier signal and to transmit a response. The response is used to indicate the location of the item. Power saving functions are built into the instructional program implemented by the microprocessor.

### BACKGROUND OF THE INVENTION

Even as technology has improved our lives, it is given us even more things to keep track of. Anyone who's ever misplaced their keys knows the frustration of trying to remember the last place they had them. Now in addition to keys, the modern user has to keep track of cordless phones, cell phones, PDA's, remote controls, wallets and purses, etc.

Many people try to solve this problem by always putting their items in the same place, but any shift in a routine can frustrate this system and some things don't lend themselves to always being in the same location.

Cordless phones often have a button on the base unit to help locate the phone but this doesn't help you find your keys or remote control. There is a need for locating device that can be used to keep track of a variety of items that are easily misplaced. Additionally, there is a need for a locating device with a base station that can be securely mounted to a location which is easily accessible and whose location is known.

### SUMMARY OF THE INVENTION

A locating device has a base unit with a plurality of selectable buttons that are assigned to items a user wants to keep track of. Self adhesive transceivers are attached to the items. The base is permanently attached to a wall or cupboard. In another embodiment, a wearable bracelet works in conjunction with the base unit to provide directional information as well as serving as a portable locator unit. Both the base unit and the bracelet utilize buttons that are customizable with icons that represent the devices they locate. A microprocessor performs signal processing required to selectively transmit and receive unique electronic identifiers associated with each transceiver units. Each transceiver is adapted to receive a unique identifier signal and to transmit a response. The response is used to indicate the location of the item. Power saving functions are built into the instructional program implemented by the microprocessor.

Other features and advantages of the instant invention will become apparent from the following description of the invention which refers to the accompanying drawings.

### BRIEF DESCRIPTION OF THE DRAWINGS

FIG. 1 is a perspective drawing of a locating device according to an embodiment of the present invention.

FIG. 2 is an exploded view of the locating device shown in FIG. 1.

FIG. 3 is a perspective view of a locating device according to another embodiment of the present invention.

FIG. 4 is a perspective view of a transmitter/receiver according to an embodiment of the present invention.

FIG. 5 is a perspective view of a transmitter/receiver according to another embodiment of the present invention.

FIG. 6 is a side view of a locating device according to an embodiment of the present invention.

FIG. 7 is a front view illustrating a cover of a locating device according to an embodiment of the present invention.

### DETAILED DESCRIPTION OF THE INVENTION

Reference is now made to the drawings in which reference numerals refer to like elements.

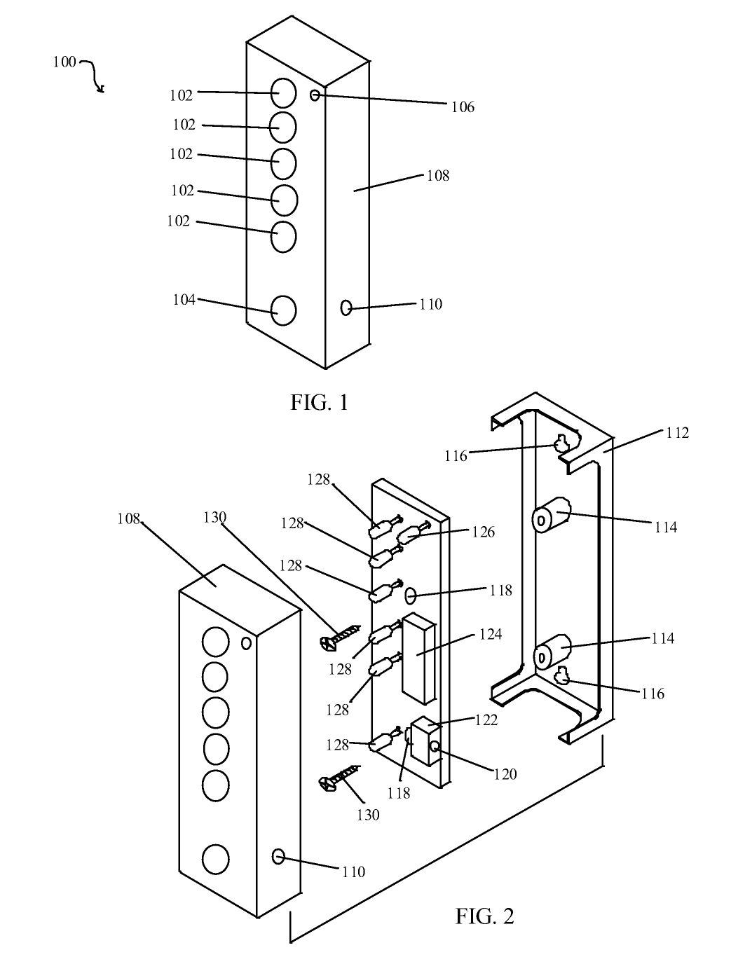

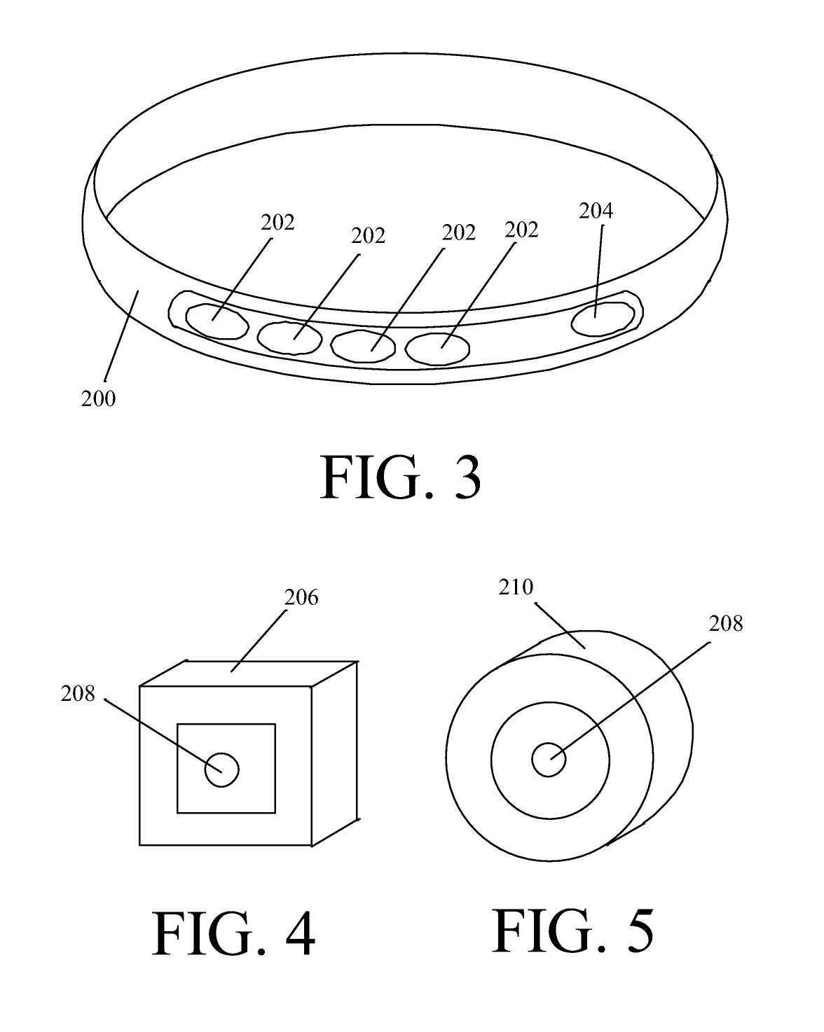

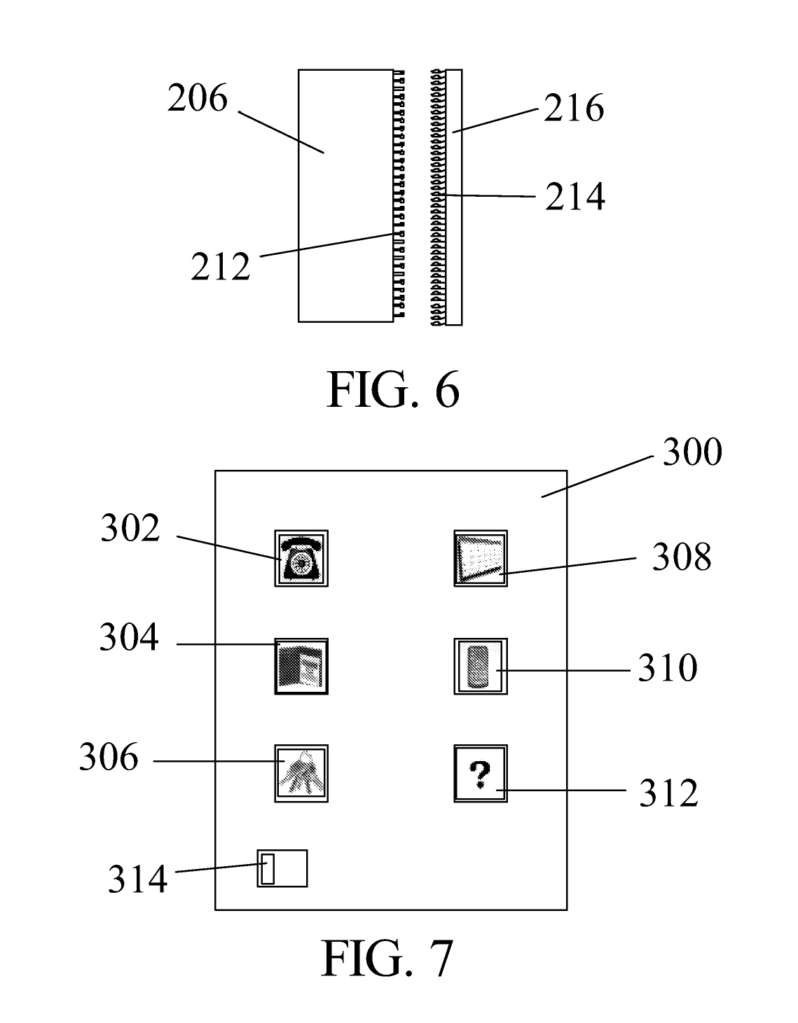

Referring to FIGS. 1 through 6, a locating device is shown having a base 100 with a cover 108 and a plurality of indicating pushbuttons 102 that correspond with transceivers 206 or 210. Base 100 has an attachment base 112 that supports a circuit board 140 using spacer supports 114. Screws 130 fit through holes 118 in circuit board 140 into spacer supports 114 to hold circuit board 140 securely in place. Of course other mounting arrangements are suitable as is known in the art. A microprocessor 124 is used to generate a unique signal that is transmitted to transceiver 206 or 210 and a secondary transceiver unit configured as a bracelet transceiver 200. Both transceivers also have microprocessors (not shown) which “listen” for the signal inquiry sent from base 100. When the signal is received, the transceivers generate a “reply” which is sent to base 100.

Additionally, bracelet 200 receives the signal from transceivers 206 or 210 and transmits a second locating signal to base 100. Microprocessor 124 then compares the signals and sends a locating signal to bracelet 200. The user is guided to the selected item by a sensory indicator such as a sound or light which is modulated in response to the locating signal. The microprocessor samples the signals and compares the time difference which allows the microprocessor to determine how close the bracelet is to the item and if the user is moving closer or farther away from the item.

Power is provided to base 100 by plugging in an energy source (not shown) into power adapter plug 120. Power input 122 includes electronic circuitry to provide the required electrical input to power circuit board 140 and microprocessor 124. LED indicator lights 128 are also powered by power input 122. A power on switch 104 is provided to control the operation of base 100. Slots 116 are used to secure attachment base 112 to a selected location (not shown) such as a kitchen cabinet, drawer or other accessible location to ensure that the base is not misplaced.

Bracelet 200 has a plurality of indicator buttons 202 which serve similar functions to buttons 102 on base 100. A power button 204 is provided to activate bracelet 200. A battery pack (not shown) uses small circular batteries joined in series to provide the required voltage to operate the transceiver and microprocessor (not shown) built in bracelet as is known in the art. Although bracelet 200 is used in conjunction with base 100 to provide directional information, it is also possible to use bracelet 200 without receiving information from base 100 but in this mode, the bracelet 200 simply activates transceiver 206 or 210 and does not give directional information. The misplaced item would then be located by an audible indicator but the audible signal would not vary as a user moves.

Piezoelectric speaker 208 is mounted on transceiver 206 or 210 as is powered by small circular batteries (not shown) electrically connected therein and also providing power to the transceiver. Also, it is within the intended disclosure to use other configurations for the secondary unit rather than just a bracelet, such as a small pocket size unit (not shown), belt clip unit (not shown), necklace (not shown) or other configuration as long as the secondary transceiver unit is portable to allow a user to move around a space and receive clues as to what direction to go in order to locate the misplaced item.

In one embodiment, transceiver 206 or 210 is attached to an item using a hook and loop fastener 212 and 214. A self-stick adhesive strip 216 is attached to an item (not shown) by a user. Transmitter 206 or 210 can then be removed to replace the battery (not shown) etc. and then easily put back in place using the hook and loop fasteners 212 and 216. Of course it is apparent that other mounting configurations are possible to mount transceiver 206 or 210 to an item.

Referring to FIG. 7, an alternate embodiment of a base 300 of a locating device is shown having a plurality of buttons. An icon representing the item located by pressing that button is displayed. In the embodiment shown, a button locating a telephone 302 is shown with an icon of a telephone. The telephone button 302 may be lighted internally to ease in use in dark conditions. The buttons represented in this embodiment include a wallet 304, keys 306, organizer 308, remote control 310 and an unassigned button 312. The user configures the base 300 by selecting the icon from an included sheet (not shown) of icons and placing it in the appropriate button space. The transmitter is placed on the selected item and then when the user desires to locate that item, the corresponding button is pressed.

A power on/off switch 314 is provided to control power to the base. The user may also write on blank labels to allow locating devices without a provided icon and placed in a button location. Although this embodiment is shown with 6 buttons, other embodiments could include more or less buttons depending on the user's needs.

The transceivers 206 or 210 and the bracelet transceiver 200 include a power saving function to extend battery life as is known in the art. The transceivers shut down and then “wake up” to poll for an incoming signal on a predetermined interval. This function is transparent to the user and the cycling occurs at a rate that ensures that the unit operates without a noticeable delay.

Additionally, if bracelet 200 is misplaced, base 100 or 300 may include a button to help locate it. Of course, additional directional clues will not be provided if bracelet 200 is misplaced since bracelet 200 will remain stationary until located. In this embodiment, bracelet 200 will emit an audible sound for a given amount of time such as 1 minute when an appropriate button is pressed on the base 100 or 300 to help the user to locate bracelet 200.

A low battery warning function may also be included to cause a small audible beep or flash of light to be produced at a slow rate such as every five minutes etc. as is known in the art when the battery is nearing the end of it charge. This allows a user the opportunity to replace the batteries before failure.

Although the instant invention has been described in relation to particular embodiments thereof, many other variations and modifications and other uses will become apparent to those skilled in the art.

What is claimed is:

1. A locating device for identifying the location of a misplaced item comprising:
a base unit having a plurality of user selectable buttons;
said base unit having control circuitry disposed therein whereby when user selects one of said plurality of user selectable buttons, a unique identifier signal is transmitted;
a plurality of user mountable transceivers adapted to be attached to selected items;
said transceivers being adapted to receive said unique identifier signal and to transmit a response;
a power source electrically connected to said base adapted to provide the required energy to energize said control circuitry; and
said transceivers having a power source connected therein.

2. A locating device for identifying the location of a misplaced item according to claim 1 further comprising a secondary transceiver unit adapted to transmit and receive a unique identifier signal.

3. A locating device for identifying the location of a misplaced item according to claim 2 wherein said secondary transceiver unit is a bracelet.

4. A locating device for identifying the location of a misplaced item according to claim 2 wherein said secondary transceiver unit is further adapted to indicate a direction to said misplaced item.

5. A locating device for identifying the location of a misplaced item according to claim 4 wherein said secondary transceiver unit indicates direction by emitting an audible sound.

6. A locating device for identifying the location of a misplaced item according to claim 5 wherein said audible sound changes pitch to indicate location of said misplaced item.

7. A locating device for identifying the location of a misplaced item according to claim 5 wherein said audible sound changes a repeat rate to indicate location of said misplaced item.

8. A locating device for identifying the location of a misplaced item according to claim 4 wherein said secondary transceiver unit indicates direction by emitting a visible indicator.

9. A locating device for identifying the location of a misplaced item according to claim 8 wherein said visible indicator changes color to indicate location of said misplaced item.

10. A locating device for identifying the location of a misplaced item according to claim 8 wherein said visible indicator changes a blinking rate to indicate location of said misplaced item.

11. A locating device for identifying the location of a misplaced item comprising:
a base unit adapted to be permanently mounted to a selected location;
at least one transceiver having an attachment means for attaching to a selected item;
a secondary transceiver unit;
said base unit having a first means for wirelessly communicating with said at least one transceiver;
said secondary transceiver unit having a second means for wirelessly communicating with said base unit and said at least one transceiver to indicate location of said misplaced item;
an indicator means disposed on said secondary transceiver unit for indicating a direction of said misplaced item; and
a selection means disposed on said base unit for selecting said misplaced item.

12. A locating device for identifying the location of a misplaced item according to claim 11 wherein said first and second means is a microprocessor.

13. A locating device for identifying the location of a misplaced item according to claim 12 wherein said indicator means is an audible signal generator.

14. A locating device for identifying the location of a misplaced item according to claim 13 wherein said audible signal generator is a piezoelectric speaker.

15. A locating device for identifying the location of a misplaced item according to claim 12 wherein said indicator means is an optical indicator.

16. A locating device for identifying the location of a misplaced item according to claim 15 wherein said optical indicator is an LED.

17. A locating device for identifying the location of a misplaced item according to claim 11 whereby said selection means is a button in electrical contact with said first means for communicating a user's selection to said first means.

18. A locating device for identifying the location of a misplaced item according to claim 16 wherein said LED is adapted to have a flash rates corresponding to how close said secondary transceiver unit is to said misplaced item.

19. A locating device for identifying the location of a misplaced item according to claim 14 wherein said piezoelectric speaker is adapted to beep with a rate corresponding to how close said secondary transceiver unit is to said misplaced item.

20. A locating device for identifying the location of a misplaced item according to claim 11 wherein said attachment means is a hook and loop fastener.
